(19) United States
(12) Patent Application Publication
(10) Pub. No.: US 2003/0014899 A1
(43) Pub. Date: Jan. 23, 2003

(54) Single piece, side mounted adapter for a fishing rod

(76) Inventors: Jerome Kollodge, Sisters, OR (US); Deborah Kollodge, Sisters, OR (US)

Correspondence Address: STRATTON BALLEW PLLC, 213 South 12th Avenue, Yakima, WA, 98902, US

(21) Appl. No.: 09/912,240

(22) Filed: Jul. 23, 2001

(51) Int. Cl. A01K 87/00

(52) U.S. Cl. 43/25

(57) ABSTRACT

An off-axis adapter for an offset fishing rod coupling formed from a single piece of sheet material. The adapter includes a sleeve having two ends. The two ends of the sleeve are each attached to a support and each support has a rod mount and a sleeve connection. The rod mounts each attach to a primary rod at mounting points, and the sleeve connections attach to the sleeve proximate to each respective end of the sleeve. The sleeve receives and maintains a secondary rod in a predetermined off-axis position and angle in relation to the primary rod. Because the adapter is attached from the length or side of the host or primary rod, the installation of the adapter does not require matching dimensions of a host rod and a bushing. The adapter can be installed onto a side portion of a fishing rod that has already been built and does not require removal of fishing rod components. Stress from secondary rod forces is distributed over the separation of mounting points for the adapter rather than over the diameter of the rod as with conventional adapters and ferrules. The adapter is flexible to the natural and bending action of the rod, and substantially eliminates stiffening and stress on the fishing rod as compared with conventional off-axis adapters. The adapter can also include optional sleeve shapes and alternate off-axis positions, angles and tapered configurations.

### TECHNICAL FIELD

The invention relates to a fishing rod attachment and a method for installing the rod attachment to the fishing rod, and more particularly to an adapter apparatus for an offset rod coupling formed from a single piece of sheet material, the adapter attachable to a conventional fishing rod.

### BACKGROUND OF THE INVENTION

Fishing rods typically include structural attachments for many purposes. For example, fishing line guides are usually mounted to the rod at short intervals. Another type of attachment structure is utilized to attach a reel to the fishing rod. The reel attachment typically includes a pair of bushings that have threaded washers on the rod to tighten the bushings and secure the reel to the rod. Additional structures include end ferrules or bushings for the end-to-end connection of multiple rod sections. These end ferrules typically mount to the ends of fishing rod sections and usually include a receptacle base that receives a rod end extension from the adjoining rod. This end-to end ferrule connector can also be called a co-axial connector, because the two rod sections share the same axis when joined.

The present invention relates to an improved “off-axis” adapter, as opposed to the co-axial adapter discussed above. Off-axis fishing rod adapters align two rod sections of the rod in the off-axis, with a predetermined angular relationship to each other. Such off-axis adapters can be employed where a rod or device must be joined parallel to, or at an angle from, the fishing rod. Examples of fishing rods with parallel off-axis adapters include Compound Fishing Rods™, which are manufactured by Sisters Compound Rods of Sisters, Oreg., U.S.A, and conventional, side-by side telescoping rods.

Fishing rods with off-axis angles are useful in “strike indicators” and “spring bobbers.” A typical off-axis adapter for joining rods comprises an elongated housing with two bushings or ferrules, each off-axis to the other. One bushing acts as the base of the adapter, which attaches to a first rod and the second bushing acts as a receptacle for a second rod. The base is joined with the first or host rod, by inserting one end of the host rod into the base bushing. The second or guest rod, attaches to the adapter receptacle by inserting one end of the guest rod into the receptacle bushing. This known adapter attachment joins the guest and host rods in an off-axis relationship to each other.

These prior adapters with pairs of bushings have substantial structure connecting the first bushing to the second bushing. Therefore, these bushing pairs include thick cross-sectional areas parallel to the bushing axis. Consequently, these adapters are substantially rigid and stiff, and are relatively heavier than simpler fishing rod attachments, such as line guides, that attach onto the rod.

Paired bushing adapters can be a disadvantage in that they can constrain and stiffen the fishing rod over the length of the base bushing. This stiffening impairs the flexibility and action of the host fishing rod, including the flex of the rod along the length of the bushing. Also, the added weight of the paired bushing adapter further impairs the action of the rod because of a resultant increase in inertia. Additionally, when the host fishing rod bends in reaction to a force, a high stress develops in the rod near the ends of the bushing. The stress can cause the host rod to fracture from a smaller bending force than that at which it would fracture without a bushing. The dimensions of the base bushing and host rod must be closely matched when installing such an adapter. The need to compensate for bushing stiffness and precisely match the diameter of the base bushing with the diameter of the host rod makes the building of a fishing rod with off-axis adapters more difficult than building conventional co-axial rods. A bushing adapter is needed that allows the rod to maintain its normal and existing rod flex, which is by design, unconstrained by a sleeved bushing.

Furthermore, it is sometimes desired to install an adapter on a fishing rod that has already been built. Such a retrofit installation is even more difficult with a paired bushing because of a need to first remove rod components before the host rod can be inserted into the bushing

Additionally, ferrules and bushings are structurally “non-compliant,” in that they do not adjust to fit a range of connecting rods. Precise dimensional control of both the male and female sections of the connecting rods are for a secure connection. Dimensional variations can result in an interference fit where it is difficult to complete a connection, or can result in a loose fit, which typically requires a deliberate distortion of one or the other ferrules to obtain a secure connection.

Still further, the cylindrical shape and longitudinal taper of a ferrule, similar to that of a cylinder, allows for twisting and turning of the mated guest rod within the ferrule.

Consequently, building fishing rods that comprise conventional off-axis adapters with conventional base bushings is difficult. Additionally, the action and strength of fishing rods having such adapters are substantially impaired because of the limitations imposed by the bushings.

There is, therefore, a need for an adapter that is easier to install than these conventional bushings, and that can be installed on a fishing rod without the need to first remove fishing rod components.

There is also a need for a lighter weight adapter that, when attached to a fishing rod, is substantially rigid and strong but does not impair the flexibility and strength of, or add undesirable weight and inertia, to the fishing rod.

Furthermore, there is a need for an adapter for off-axis joining in which the sleeve is compliant or adaptive to receive a moderately over-sized guest rod.

Still further, there is a need for an adapter for off-axis joining that is constructed to further reduce the weight and inertia of the adapter, increase the strength of the rod to which it is attached, and reduce twisting and turning of the guest rod.

### SUMMARY OF INVENTION

The present invention provides an off-axis adapter for an offset fishing rod coupling. The adapter includes a ferrule, or sleeve, having a “longitudinal” or lengthwise split. The longitudinal split in the sleeve provides “structural relief,” in that it accommodates and gives compliance in the receiving of an over-sized “guest” or secondary rod. The longitudinal split or sleeve split, additionally provides a spring-loading to the receiving sleeve for a more secure connection to the secondary rod. The split is a continuous, lengthwise void in material along a side of the sleeve.

Also, the generally cylindrical shape and longitudinal taper of the sleeve can be easily altered to eliminate a twisting of the secondary rod in the adapter. The optional shapes of the sleeve include those of polygons having as few as three sides, triangular, to a number approaching infinity, which results in a smooth, circular shape. Additionally, the polygonal sleeve may be regular, having sides of equal length, or irregular. Those shapes bound the shapes that can easily be provided in sleeve of the adapter.

The sleeve attaches to the side of a host, or primary, rod in a manner similar to that of a line guide. Thereby the need to match bushing and rod dimensions for installation is eliminated. The supports can easily be altered to introduce optional off-axis distances and angles for the sleeve.

A sleeve support is connected to each end of the sleeve. A first support is connected to the first end of the sleeve at a first connection. The first support has a first rod mounting area that is attachable to a host, or primary, rod at a first mounting point..

A second support is connected to the second end of the sleeve at a second connection. The second support has a second rod mounting area that is attachable to the primary rod at a second mounting point.

Optionally, the first and second supports have an offset angle from the sleeve and have connected a first and a second rod mount, wherein the rod mounts comprise the first and second mounting area, respectively. A first and second mounting distance, from the respective support connections to the rod mounts, determines the off-axis position and angle for the sleeve. The sleeve receives and maintains a secondary rod at a predetermined position and angle in relation to the primary rod.

The method of the invention includes producing an integral or “monolithic” adapter with a conventional process of folding or molding structural sheet-material to produce permanent bends. A starting sheet is cut, shaped, or stamped from raw sheet-material and comprises a first sheet end, a sheet body, and a second sheet end, wherein each has the shape and area equivalent the surfaces of the first support, the sleeve and the second support, respectively. The body also has a first side and a second side, each side having a length equal to that of the sleeve length.

The adapter sleeve is produced by a first and second fold and bend of the first and second body sides against a die, the die having a shape of the inside surface for the sleeve.

Thereby the adapter is produced as an integral structure that includes the sleeve, and has a “longitudinal” or lengthwise split at the interface of the bent first and second body sides, between the supports that are integrally connected to the sleeve.

Other aspects of the invention include additional steps, wherein the folds and bends have predetermined angles and wherein the angles are directed away from the sleeve.

Accommodation for off-axis position and angle for the sleeve is produced by a third and fourth fold and bend, of the first and second sleeve supports, the folds centered on the respective support connections; thereby the sleeve supports are directed off- axis from the sleeve.

The first and second rod mounts, respective mounting areas, and off-axis position and angle for the sleeve are produced by a fifth and sixth fold and bend, of the first and second supports. The folds are centered at predetermined first and second mounting distances, respectively. The mounting distances determine the off-axis position and angle for the sleeve.

Thereby, an integral or “monolithic” adapter is produced having a predetermined size and shape, and a predetermined off-axis position and angle for the sleeve in relation to the primary rod.

The adapter is attached to a primary rod and a secondary rod inserted into the sleeve, the sleeve for maintaining the secondary rod at the predetermined off-axis position and angle in relation to the primary rod.

The method of attaching the adapter mounting areas to the primary rod is similar to that for line guides wherein they are first wrapped with a thread material and the thread coated with a suitable epoxy, or bonding agent. Alternatively, a high strength, semi-flexible epoxy can be applied to the primary rod at the mounting points to obtain a surface to surface bond with the adapter mounting areas.

According to one aspect of the invention, because the adapter is attached from the length or side of the host or primary rod, the installation of the adapter does not require matching dimensions of a host rod and a bushing, thereby easing the installation.

According to another aspect of the invention, an apparatus is provided for installation onto a side portion of a fishing rod that has already been built and does not require removal of fishing rod components, thereby further easing the installation.

According to another aspect of the invention an apparatus is provided that, when installed on a rod, is flexible to the natural bending action of the rod, as designed. This flexibility of the adapter substantially eliminates the stiffening and additional stress on the fishing rod that are introduced by conventional ferrules and off-axis adapters.

According to yet another aspect of the invention an apparatus is provided that is lightweight, thereby reducing the weight and inertia of the fishing rod to which it is attached.

According to still another aspect of the invention an apparatus is provided in which the sleeve has a structural relief, is compliant to over-sized secondary rods and provides a spring loading for a secure connection.

According to still another aspect of the invention an apparatus is provided in which options to the shape and taper of the sleeve are easily produced, thereby accommodating secondary rods with alternate shapes to eliminate twisting in the adapter.

According a further aspect of the invention an apparatus is provided in which changes to the off-axis distance and angle for the sleeve are easily produced, thereby increasing the applications for the apparatus.

According to yet a further aspect of the invention an apparatus is provided that is easily produced as an integral, monolithic, structure, thereby further reducing weight and inertia and improving the strength, stiffness and flexibility characteristics.

The foregoing objects are achieved with a side-mounting adapter that is easily produced as an integral, monolithic, structure from a single piece of sheet-material and can easily be installed from, and attached to, the side of a fishing rod. The side-mounting adapter is lightweight and flexible, and responds to the bending of the host rod, to which it is attached.

Further, the adapter sleeve is compliant to moderately over-sized secondary rods, provides spring loading for a secure connection and can have optional shapes and tapers, and optional off-axis positions and angles, such as generally cylindrical forms that include regular and irregular polygons. The present invention will be better understood by reference to the following detailed description taken in conjunction with the accompanying drawings.

### BRIEF DESCRIPTION OF DRAWINGS

FIG. 1 is a perspective view of an adapter for a fishing rod coupling, according to an embodiment of this invention;

FIG. 2 is a perspective view of an adapter for a fishing rod coupling, according to an embodiment of this invention;

FIG. 3 is a perspective view of an adapter for a fishing rod coupling, according to an embodiment of this invention;

FIG. 4 is a perspective view of an adapter for a fishing rod coupling, according to an embodiment of this invention;

FIG. 5 is a perspective view of an adapter for a fishing rod coupling, according to an embodiment of this invention;

FIG. 6 is a perspective view of an adapter for a fishing rod coupling, according to an embodiment of this invention;

FIG. 7 is a perspective view of an adapter for a fishing rod coupling, according to an embodiment of this invention; and

FIG. 8 is a perspective view of an adapter for a fishing rod coupling, according to an embodiment of this invention.

### DETAILED DESCRIPTION OF SPECIFIC EMBODIMENTS

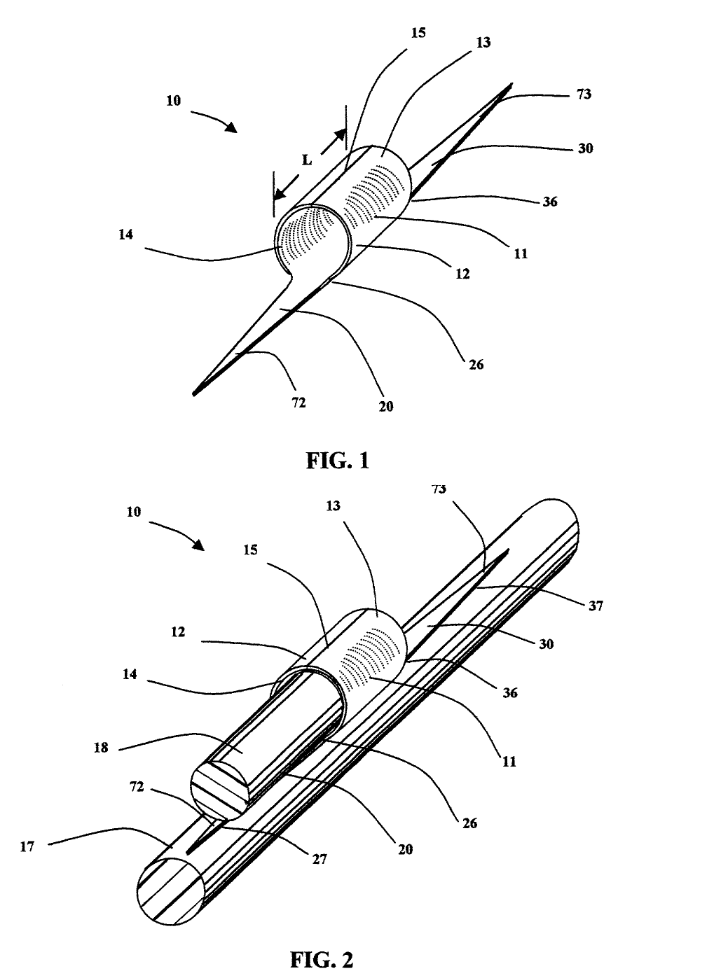

The invention provides a rod coupling or adapter for a pair of offset segments of a fishing rod. FIGS. 1 through 8 show preferred embodiments of the invention, which is an adapter 10 formed of a single piece of material, the adapter for coupling fishing rods.

As shown in FIG. 1, the adapter 10 includes a sleeve 11 having a first sleeve end 12, a second sleeve end 13, a length L and a longitudinal split 15. The longitudinal split in the sleeve is essentially a continuous, lengthwise void or gap along the sleeve. The first sleeve end includes a receptacle 14, the receptacle for receiving a secondary rod 18, as shown in FIG. 2. The longitudinal split provides a structural relief and compliance in the sleeve if the secondary rod is moderately over-sized. Additionally, by forcing the longitudinal split to widen in receiving the secondary rod, the longitudinal split provides a “spring loading,” for a more secure connection with the secondary rod.

As further shown in FIGS. 1 and 2, the sleeve 11 includes a first support 20 adjacent to the first sleeve end 12 of the sleeve at a first sleeve connection 26, and a second support 30 adjacent to the second sleeve end 13 of the sleeve at a second sleeve connection 36. The first support includes a first mounting area 72, the first mounting area attachable to a primary rod 17 at a first mounting point 27, as detailed in FIG. 2. Similarly, the second support includes a second mounting area 73, the second mounting area attachable to the primary rod at a second mounting point 37 also shown in FIG. 2. The primary mounting abuts to the primary rod at the first mounting point. Similarly, the secondary mounting abuts to the primary rod at the secondary mounting area. The first mounting area and the second mounting area are both portions along the length of the primary rod, as opposed to cross-sectional tip ends. With the adapter 10 secured to the primary rod, it receives and maintains the secondary rod 18 at a predetermined position in relation to the primary rod, onto which the adapter mounts.

A preferred embodiment of the adapter 10, as shown in FIG. 1, provides a minimal “off-axis” position, away from the primary rod 17, which is most beneficial in connecting the secondary rod 18 near a tip end 19 of the primary rod. This closely parallel positioning of the secondary rod in relation to the primary rod achieves a substantial reduction in stress to the primary rod from forces generated by bending action of the secondary rod. With a conventional co-axial ferrule, these bending forces would be distributed over the relatively small diameter of the primary rod end, thereby producing a large stress as compared to distributing the connective forces over the first mounting area 72 and the second mounting area 73, as achieved with the present invention. Additionally, the adapter of the present invention distributes stress over the substantially large separation between the first mounting point 27 and the second mounting point 37, as shown in FIG. 2, thereby significantly reducing stresses at the connection between the primary rod and the secondary rod.

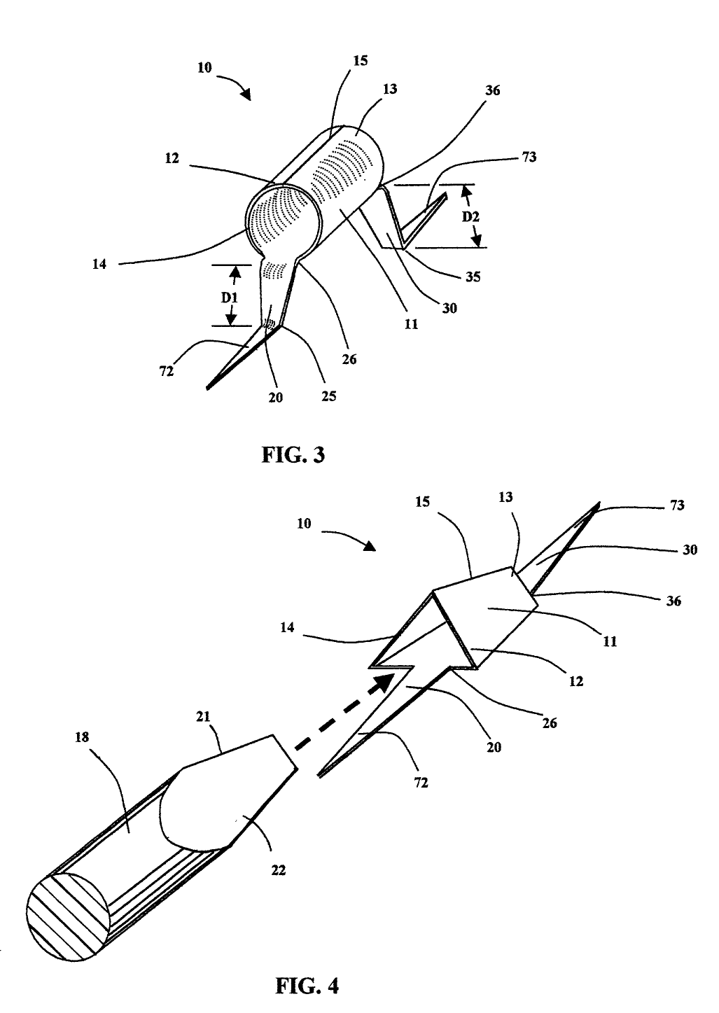

FIG. 3 shows a preferred alternative embodiment of the present invention, wherein the first support 20 of the sleeve 11 includes a first rod mount 25 and a first mounting distance D1. The first mounting distance is defined as the distance from the first rod mount to first sleeve connection 26. The first rod mount includes the first mounting area 72. Similarly, the second support 30 of the sleeve includes a second rod mount 35 and a second mounting distance D2. The second mounting distance is defined as the distance from the second rod mount to the second sleeve connection 36. The second rod mount 35 includes the second mounting area 73. Dimensions of the first mounting distance D1 and second mounting distance D2 determine an “off-axis” position and angle for the sleeve. If the first mounting distance and the second mounting distance are zero, the adapter mounts flush to the primary rod, as shown in FIG. 2.

Alternatively, the first mounting distance D1 and the second mounting distance D2, can separate the sleeve 11 of the adapter 10 from the primary rod 17, and the adapter would appear as shown in FIG. 3. The adapter 10 of FIG. 3, provides a substantial off-axis position for the sleeve 11, as is most beneficial for mounting the adapter at a distance from the tip end of primary rod, to avoid an interference between the secondary rod 18 and the primary rod. Interference between the secondary rod and the primary rod can be further avoided with differing first mounting distance and second mounting distance, which would also place the primary rod and the secondary rod at an offset angle. For this alternative and offset angle, off-axis mounting of the secondary rod, the first mounting distance is substantially unequal to the seconds mounting distance to produce this off-axis angle in the sleeve.

As shown in FIGS. 1 through 3, a preferred sleeve 11 is cylindrical in shape. However, for the present invention, the sleeve can be alternatively defined as a polygonal shaped, tapered, housing. Alternatively, polygonal shapes and tapers can be easily produced in the sleeve of the adapter 10. The generally cylindrical shaped sleeve, as shown in FIGS. 1 through 3, is the preferred regular polygon, can be technically described as having an infinite number of incremental sides to form a cylinder. The general form of the sleeve can be described as “generally cylindrical,” in that it is has an outside, tubular perimeter. Additionally, the preferred generally cylindrical sleeve does not include a taper. “Taper” is herein defined as having the first sleeve end 12 a differing diameter from the second sleeve end 13.

In a preferred alternative, as shown in FIG. 4, the sleeve 11 is polygonal, and specifically triangular in shape and so exemplifies a preferred irregular polygon, having sides of unequal length, and having a taper. Any sleeve, of any generally cylindrical shape, or polygonal shape, having any appropriate taper is considered within the scope of the present invention. However, the inventors have found that the generally cylindrical shape of a polygon shaped sleeve, having sides numbering approximately less than ten, and receivable to the corresponding, mating secondary rod, is most beneficial to eliminate, or at least minimize any twisting of the secondary rod within the sleeve. As shown in FIG. 4, the preferred alternative secondary rod 18 shown in FIG. 4 includes both a matching generally cylindrical shape 21 and a matching longitudinal taper 22. The matching generally cylindrical shape illustrated in FIG. 4 is triangular. The secondary rod is inserted easily into the sleeve that is shaped about its perimeter and tapered along its length to receive the like shaped end of the secondary rod.

For the installation of the adapter 10 onto the primary rod 17, several alternative methods for fabrication and mounting can be employed, all of which are conventionally employed for other components of fishing rods. When installed on a fully functional primary rod, the sleeve 11 of the present invention is essentially a side-mounted adapter. The term “side-mounting” refers to an installation of the adapter other than the conventional slide-on, co-axial, sleeved mounting that is required of typical adapters and ferrules. The adapter of the present invention can be installed along the length of the primary rod, and so side-mounted to the primary rod, instead of inserted onto the terminal end of a stripped down rod, which then must be reassembled. Several side mounting rod adapters and attachment methods are disclosed and discussed in co-pending and commonly signed U.S. patent application Ser. No. 09/346,512, filed Jul. 1, 1999, now U.S. Pat. No. 6,263,609.

The primary rod 17 can be any conventional fishing rod, as the first mounting area 72 and the second mounting are 73 are configured similar to the rod mounts of conventional line guides and can be mounted to a rod of any typical diameter. Many conventional attachment techniques can be employed to attach the first mounting area and second mounting area of the adapter 10 to the primary rod. The attachment is the actual bonding method employed that securely and immovably attaches the mounting areas to the primary rod and is equivalent to that used for mounting line guides. The first mounting area and the second mounting area are preferably attached to the primary rod by first wrapping them with a thread-like material to secure them firmly to the primary rod, and then applying a suitable epoxy, or bonding agent over the thread to achieve a strong and permanent mounting.

Alternatively, a high strength, semi-flexible epoxy can be applied the primary rod 17 at the first mounting point 27 and second mounting point 37, to hold the first mounting area 72 and the second mounting 73 area to the primary rod with a surface to surface bond, as shown in FIG. 2. With the adapter 10 mounted and attached to the primary rod, the first mounting area is substantially separated from the second mounting area. This separation of the first support and second support imparts the improved flexing properties that make this improved adapter significantly superior to conventional off-axis adapters and co-axial ferrules that have solid and continuous mountings to the primary rod over the full length of the ferrule. The first support 20 and the second support 30 of the sleeve 11 in the adapter allow the primary rod to maintain a normal rod flexing that is unconstrained and substantially stress-free.

The first support 20 and the second support 30 each impart improved structural properties of stiffness and flexibility to the adapter 10 of the present invention, especially as compared with conventional, off-axis adapters and co-axial ferrules. The first and second supports are substantially stiff and resistant to twisting about the sleeve 11. However, the first and second supports specifically allow for the primary rod 17 to flex and twist between the first mounting areas 72 and second mounting area 73. For such directionally specific stiffness and flexibility, the first sleeve connection 26 and the second sleeve connection 36 are substantially rigid, as with the mounting of the first and second supports to the primary rod. The first and second supports are flexible to the bending of the primary rod. Thereby primary rod is not substantially stiffened by the attachment of the improved adapter.

Further advantages of the present invention result from producing the adapter 10 as an integral, monolithic, structure from a single piece of sheet-material. A preferred production method includes the conventional process of folding or molding structural sheet-material to produce permanent bends.

Structural sheet-materials include sheets of ductile materials such as aluminum, brass, copper, steel, and compositions. They also include sheets of flexible materials such as fiberglass and carbon composition cloths that, when molded, are impregnated with an epoxy to obtain structural integrity upon curing of the epoxy. Most ductile materials can be treated to a harder condition after they are processed, to improve strength, stiffness and flexing characteristics. The use of ductile materials is preferred because it affords a more precise dimensional control than does molding with flexible cloths and epoxy. Precision bends are achieved by folding the material, with high pressure, against a mold or tooling die to replicate the die shape in the bend. There are many benefits to this approach, which inherently produces the longitudinal split 15 of sleeve 11 for structural relief. Optional shapes and tapers for the sleeve are easily produced. Optional off-axis positions and angles for the sleeve are easily introduced. Weight and inertia are reduced and strength, stiffness and flexing characteristics are improved.

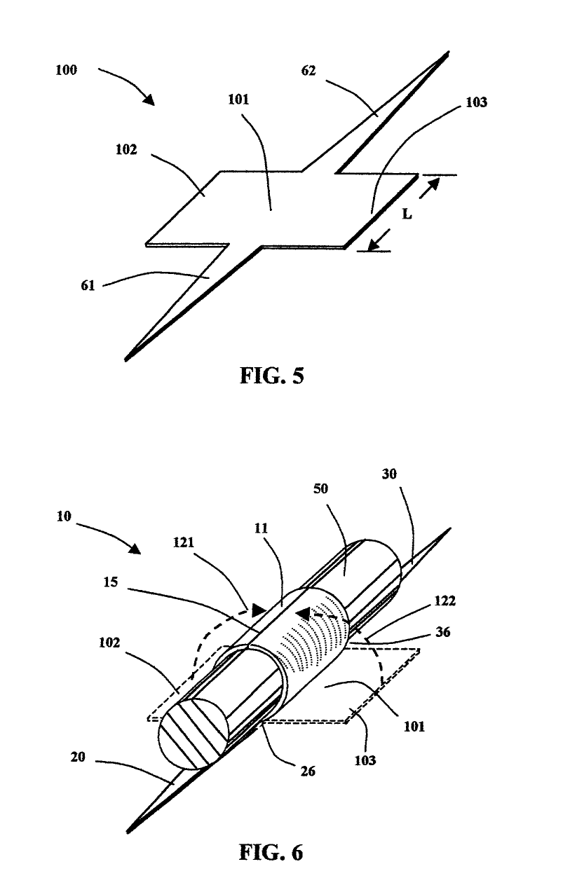

FIGS. 5 through 8 illustrate the steps to produce adapter 10, as an integral structure, comprising the aspects and embodiments of the invention. The cylindrically shaped sleeve of FIG. 1 is used for example, thereby requiring use of a cylindrical tooling die 50 having the shape and dimensions of the inside surface of sleeve 11, as illustrated in FIG. 6.

The steps are equivalent for optional shapes and tapers for sleeve 11 and optional off-axis positions and angles for the adapter10 wherein the shape of the die 50 would match that for the optional sleeve shape.

FIG. 5 shows a starting sheet 100 that has been cut, shaped or stamped from raw sheet-material. Sheet 100 having a first sheet end 61, a sheet body 101 and a second sheet end 62. The first sheet end comprises a shape and area of the first sleeve support 20 surface, the body comprises a shape and area of the sleeve 11 surface and the second sheet end comprises a shape and area of the second sleeve support 30 surface. The body also having a first side 102, and a second side 103, wherein the length of the first and second sides is equal to the sleeve length L.

FIG. 6 illustrates folds and bends for sheet body 101 to produce sleeve 11. A first fold 121 of the first side 102 against the tooling die 50 produces a permanent, replicating bend in the first side. A second fold 122 of the second side 103 against the die produces a permanent replicating bend in the second side, thereby completing the sleeve. Additionally, the longitudinal split 15 needed for structural relief is inherently produced at the interface of the folded sides.

With this method of fabrication, the adapter 10, as shown in FIG. 1, is produced as an integral, monolithic, structure and includes the aspects of; first support 20 integrally connected to sleeve 11 at first sleeve connection 26 and second support 30 integrally connected to the sleeve at second sleeve connection 36.

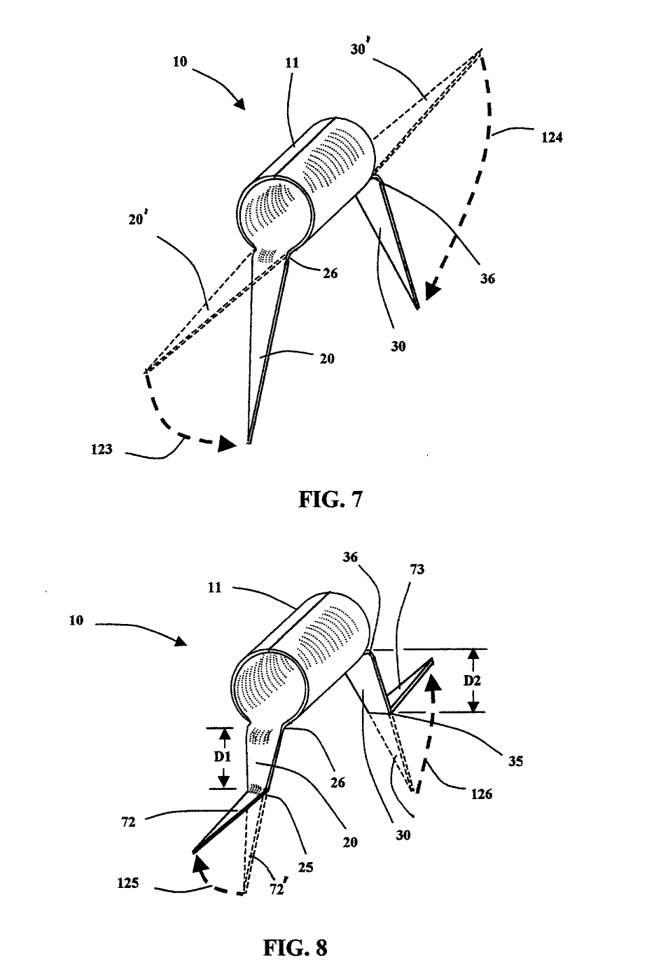

Further embodiments of the invention include additional steps wherein the folds and bends have predetermined angles and are directed away from the sleeve 11. FIG. 7 illustrates folds and bends for the first support 20 and second support 30 to accommodate off-axis positioning of sleeve. A third fold 123 from a sheet end position 20′ to the first support 20, and centered on first sleeve connection 26, produces a respective permanent bend at the first sleeve connection. A fourth fold 124 from a second sheet end position 30′ to the second support 30, centered on second sleeve connection 36, produces a respective permanent bend at the second sleeve connection. Thereby, the first support and second support are directed at angles away from the sleeve to accommodate off-axis positioning of the sleeve 11.

FIG. 8 illustrates additional folds and bends of the first support 20 and second support 30 to produce first mount 25 and second mount 35. Additionally, predetermined dimensions for first mounting distance D1 and the second mounting distance D2 are implemented to determine the off-axis position and angle for the sleeve 11. A fifth fold 125 of first support 20, centered at first mounting distance D1 from first connection 26, produces a respective permanent bend and the first rod mount 25. The first support is bent or folded from a first support position 72′ to form the first mounting area 72, the first mounting area attachable to the primary rod 17 at the first mounting point 27, as detailed in FIG. 2. A sixth fold 126 of second support 30 and centered at second mounting distance D2 from second connection 36, produces a respective permanent bend and produces second rod mount 35. Similarly, the second support is bent from a second support position 73′ to form the second mounting area 73, the second mounting area attachable to the primary rod at a second mounting point 37 as also detailed in FIG. 2.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible that employ the same inventive concepts as described above. Therefore, the invention is not to be limited, except by the following claims, as appropriately interpreted in accordance with the doctrine of equivalents.

What is claimed is:

1. An adapter for offset fishing rod coupling, the adapter comprising:
a sleeve having a length, a first end, a second end, a first support and a second support;
the first support having a first sleeve connection, and a first mounting area, the first sleeve connection proximate to the first end of the sleeve, and the first mounting area attachable to a primary rod at a first mounting point;
the second support having a second sleeve connection and a second mounting area, the second sleeve connection proximate to the second end of the sleeve, and the second mounting area attachable to a primary rod at a second mounting point, the sleeve for receiving a secondary rod; and
the sleeve including a sleeve split, the sleeve split comprising a continuous gap along the length of the sleeve, and the sleeve split for providing a structural relief and a spring loading in the receiving of the secondary rod.

2. The adapter of claim 1, wherein:
the first support includes a first rod mount;
the second support includes a second rod mount;
the first rod mount includes the first mounting area, the first mounting area abutted to the primary rod, along a first length portion of the primary rod; and
the second rod mount includes the second mounting area, the second mounting area abutted to the primary rod, along a second length portion of the primary rod.

3. The adapter of claim 1, additionally comprising:
a secondary rod received into the sleeve, the secondary rod including a matched generally cylindrical shape in relation to the sleeve and a matched longitudinal taper in relation to the sleeve, the matched generally cylindrical shape and a matching longitudinal taper, both for minimizing a twisting of the secondary rod within the sleeve.

4. An adapter for offset fishing rod coupling, the adapter comprising:
a sleeve having a length, a first end, a second end, a first support and a second support;
the first support having a first sleeve connection, and a first mounting area, the first sleeve connection proximate to the first end of the sleeve, and the first mounting area attachable to a primary rod at a first mounting point;
the second support having a second sleeve connection and a second mounting area, the second sleeve connection proximate to the second end of the sleeve, and
the second mounting area attachable to a primary rod at a second mounting point,
the sleeve for receiving a secondary rod; and
the sleeve of the adapter having a generally cylindrical shape, and the secondary rod having a matching cylindrical shape.

5. The adapter of claim 4 wherein the sleeve of the adapter additionally has a longitudinal taper, and the secondary rod has a matching longitudinal taper.

6. The adapter of claim 4 wherein:
the generally cylindrical shape of the sleeve is a polygon shape having a minimum of three sides.

7. The adapter of claim 6 wherein:
the polygon shape is a regular shape, comprising a plurality of sides of equal width.

8. The adapter of claim 6 wherein:
the polygon shape is an irregular shape, comprising a plurality of sides of unequal width.

9. The adapter of claim 4, additionally comprising:
a secondary rod received into the sleeve, the secondary rod including a matched generally cylindrical shape in relation to the sleeve and a matched longitudinal taper in relation to the sleeve, the matched generally cylindrical shape and a matching longitudinal taper, both for minimizing a twisting of the secondary rod within the sleeve.

10. The adapter of claim 4, wherein:
the first support includes a first rod mount;
the second support includes a second rod mount;
the first rod mount includes the first mounting area, the first mounting area abutted to the primary rod, along a first length portion of the primary rod; and
the second rod mount includes the second mounting area, the second mounting area abutted to the primary rod, along a second length portion of the primary rod.

11. The adapter of claim 10, wherein:
the first rod mount positioned at a first mounting distance from the first sleeve connection;
the second rod mount positioned at a second mounting distance from the second sleeve connection; and
the first mounting distance is substantially unequal to the second mounting distance for producing an off-axis angle for the sleeve.

12. The adapter of claim 1, wherein:
the first support is substantially separated from the second support by the length of the sleeve to allow normal flexing of the primary rod between the first mounting point and the second mounting point.

13. A method for an adapter for an offset fishing rod coupling, the method including the steps of:
a) forming a starting sheet from a piece of ductile sheet-material, the starting sheet having a sheet body, a first sheet end, a second sheet end and a sleeve length, the first sheet end comprising a first support surface, the second sheet end comprising a second support surface, the sheet body having a first body side and a second body side, the first body side and the second body side having a length equal to the sleeve length;
b) folding the first body side against a tooling die to produce a permanent bend having a first replicated shape of the die, the tooling die having a generally cylindrical shape and a taper;
c) folding the second body side against the tooling to produce a permanent bend having a second replicated shape of the die, the first and second replicated shapes together comprising a sleeve surface; and
d) forming an longitudinal split at an interface between the first replicated shape and second replicated shape.

14. The method of claim 13, including the additional steps of:
e) folding the first support at the first sleeve connection, to produce a permanent bend proximate the first end of the sleeve; and
f) folding the first support at an end of the first support, to produce a first mounting area, the first mounting area separated from the first sleeve connection by a first mounting distance;
g) folding the second support at the second sleeve connection, to produce a second mounting area, the second mounting area separated from the second sleeve by a second mounting distance.
